(19) United States
(12) Patent Application Publication
(10) Pub. No.: US 2015/0039675 A1
(43) Pub. Date: Feb. 5, 2015

(54) MESSAGING OVER HTTP PROTOCOL FOR DATA EXCHANGE

(71) Applicant: Microsoft Corporation, Redmond, WA (US)

(72) Inventors: Joseph Warren, Renton, WA (US); Darrell Brunsch, Redmond, WA (US); Christopher Knestrick, Bellevue, WA (US); Darren Gonzales, Kirkland, WA (US); Robert Novitskey, Redmond, WA (US)

(73) Assignee: Microsoft Corporation, Redmond, WA (US)

(21) Appl. No.: 13/955,863

(22) Filed: Jul. 31, 2013

(51) Int. Cl. H04L 29/08

(52) U.S. Cl. CPC H04L 67/02
USPC 709/203

(57) ABSTRACT

Technologies are generally provided for a protocol for retrieving data from a remote server at a local client. A client may execute a productivity service which may provide a communication application enabling users to receive messages stored at a remote server. The client may employ a messaging over hypertext transfer protocol (HTTP) to request data from the server. The messaging over HTTP protocol may incorporate specialized headers with established HTTP verbs for requesting data. An HTTP POST verb may be used to send a request to the server, and the POST request may include specialized header information specifying a content and request type, and mailbox and requesting service identification. After receipt of the POST request, the server may send a receipt response to the client, and may periodically send chunked intermediary responses processing the request to indicate the connection is still established and the request is currently pending.

### BACKGROUND

In a communications environment, a client/server relationship is often used to interconnect services that may be distributed across different remote locations. Often times a user may execute an application locally on the user's client device, and the application may retrieve data associated with the application from a remote server connected with the client device over a network. In an example scenario after a connection is established between the client device and the server, the application may forward a request to the server, and the server may in turn send a request to a database to retrieve requested data and information. The server may return the retrieved data to the client device which may display the information to the user and enable the user to interact with the data.

A remote procedure call (RPC) protocol may sometimes be used to forward a request from a local client to a remote server to retrieve requested data. The RPC protocol may cause a subroutine or procedure to be executed in a remote location or network without requiring explicit coding details for this remote interaction. The RPC protocol may involve some complex coding, however, and may require specialized configurations on the server side for enabling successful a RPC protocol for data retrieval. Additionally, some servers may become overloaded when a large quantity of users employ the RPC for accessing data due to multiple redundancy of the RPC protocol. When servers become overloaded, users can lose established connections and may be unable to reconnect, which may reduce an overall quality of experience for user, and may prevent the user from accessing data through the client application.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to a protocol for requesting and retrieving data from a remote server at a local client. A local client may execute a productivity or communications service which may provide a communication application enabling users to receive and interact with messages stored at a remote server. The client may employ a specialized messaging over hypertext transfer protocol (HTTP) to enable the client to request data from the remote server. The messaging over HTTP protocol may incorporate specialized header information with established HTTP verbs for requesting data from the server. An HTTP POST verb may be used to send an initial request to the server, and the POST request may include specialized header information specifying a content type, a mailbox identification, a requesting service identification, and a request type. When the server receives the POST request, the server may send a receipt response to the client, and may periodically send chunked intermediary responses while the server processes the request to indicate the connection is still established and the request is currently pending. After retrieving the requested data, the server may return a final response to the client including the requested data.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example environment where a client may access productivity and communication services over a network,

FIG. 2 illustrates an example data exchange between a client and a server employing messaging over HTTP protocol;

FIG. 3 illustrates example data requests and responses exchanged between a client and a server employing messaging over HTTP protocol;

FIG. 4 is a networked environment, where a system according to embodiments may be implemented;

FIG. 5 is a block diagram of an example computing operating environment, where embodiments may be implemented; and

FIG. 6 illustrates a logic flow diagram for a process of providing a protocol for retrieving data from a remote server at a local client, according to embodiments.

### DETAILED DESCRIPTION

As briefly described above, a system is described for providing a protocol for retrieving data from a remote server at a local client. A client such as a productivity or communications service may enable users to receive messages stored at a remote server. The client may employ a messaging over hypertext transfer protocol (HTTP) to request data from the server. The messaging over HTTP protocol may incorporate specialized messaging headers with established HTTP verbs for requesting data. An HTTP POST verb may be used to send a request to the server, and the POST request may include specialized header information specifying a content and request type, and mailbox and requesting service identification. After receipt of the POST request, the server may send a receipt response to the client, and may periodically send chunked intermediary responses processing the request to indicate the connection is still established and the request is currently pending. Upon retrieving the data, the server may return a final response including the requested data to the client.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or compact servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

Throughout this specification, the term “platform” may be a combination of software and hardware components for providing a messaging over HTTP protocol for data exchange between a client and a server over a network. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

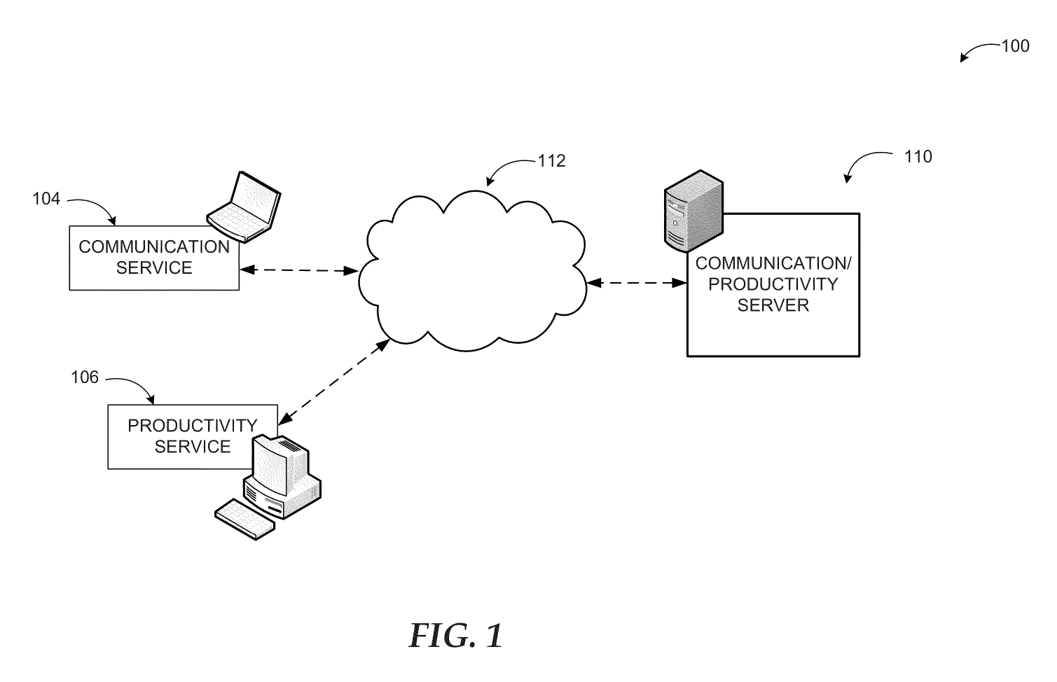

FIG. 1 illustrates an example environment where a client may access productivity and communication services over a network, according to some embodiments herein. The computing devices and computing environments shown in diagram 100 are for illustration purposes. Embodiments may be implemented in various local, networked, and similar computing environments employing a variety of computing devices and systems.

As illustrated in diagram 100, a user may employ a variety of different client devices to execute applications for exchanging and interacting with data. Example applications executed at a user's client device for interacting with data may be a productivity service 106 and a communication service 104. An example communication service 104 may be a service configured to provide email, contacts management, and calendar services. The communication service 104 may also provide real-time communications platforms, such as instant messaging, audio/visual conferencing, and presence detection. For example, a user may receive, view and reply to email and other data at the communication service 104 executed on the user's client device. Some example client devices for viewing emails and accessing other data may include as a desktop computing device, a personal computer, a tablet, a smartphone, a whiteboard and other similar client devices.

An example productivity service 106 may be configured to provide access to various services built around a productivity platform. Some productivity services may include an email application, a social networking application, a collaboration application, an enterprise management application, a messaging application, a word processing application, a spreadsheet application, a database application and a presentation application. The productivity service may also include a communication application configured to work in conjunction with the communication service to retrieve and exchange data.

The services provided by the communication service 104 and the productivity service 106 may be hosted at an external server associated with the communication service 104 and the productivity service 106. A user may access the provided services from the remote server 110 locally at a user's client device over a network 112, which may be a wired or wireless network, or a cloud network. Data between the local client device and the server may be exchanged over the network 112, such that the local client device may need to have an active connection with the server 110 over the network in order to access and interact with data provided by the communication service 104 and the productivity service 106.

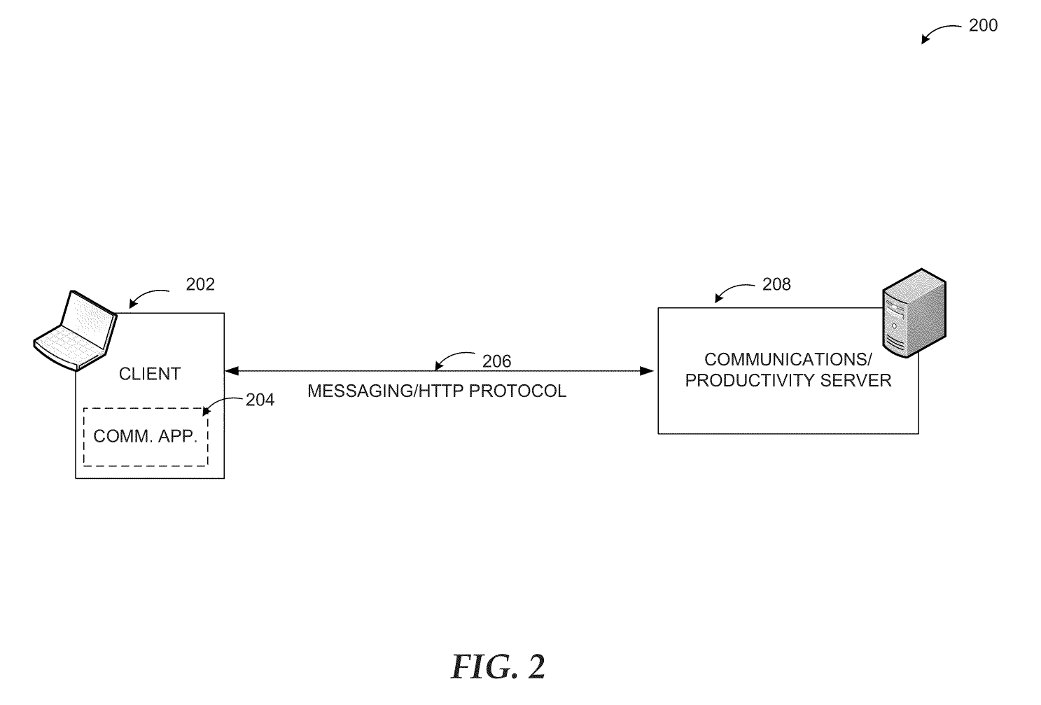

FIG. 2 illustrates an example data exchange between a client and a server employing messaging over HTTP protocol, according to some embodiments herein.

As illustrated in diagram 200, a client 202 may execute a productivity application or a communication application 204, such as an email application, on a local device. The client 202 may communicate with a server 208 over a network to retrieve data associated with the communication application 204 such as email data.

In a system according to embodiments, a connection may be established between the client 202 and the server 208 in order to enable data to be exchanged with the communication application 204. The client 202 may initiate a connection with the server 208, and may request data from the server 208. The server 208 may accept the request, process the request, and return the requested information to the client 202. Hypertext Transfer Protocol (HTTP) is an application protocol that may be employed for facilitating communication and exchange of data between the client and the server 208. The HTTP may define methods, or verbs, which may indicate the desired action to be performed by the server to retrieve requested information. For example, a verb may include a GET verb which may be a request to retrieve data. Another example verb employed in HTTP may be a POST verb which may allow the server to accept data which embodies the request.

In an example embodiment, the client 202 may incorporate a messaging protocol over established HTTP requests in order to facilitate retrieving data associated with the communication application executed at the client from the server 208. The messaging over HTTP protocol 206 may enable the client 202 to send a request to the server 208 over an HTTP connection and to receive a server response over the same HTTP connection. The client 202 may open additional HTTP connections with the server 208 to send concurrent independent requests to the server 208.

In an example embodiment, the client 202 request may incorporate data request language with traditional HTTP POST request language to generate the messaging over HTTP protocol. The messaging over HTTP protocol may include a specialized header structure for instructing the server with what data to retrieve and how to respond to the client. The specialized header structure may include a request type header, a request identification header, a mailbox identification header and a content-type header. A request type header may be an X-RequestType header which may be employed to tell the server 208 what operation the client 202 is attempting to perform. The request identification header may be an X-RequestID header which may identify the client 202 to the server 208. The server 208 may not accept un-identified or anonymous requests. Additionally, the mailbox identification header may be a MailboxID parameter that uniquely identifies an email account or mailbox associated with the client from which the server 208 is requested to retrieve email and other data. Further the POST request may include a content type header, which may be a Content-Type header set to “application/octet-stream.”

An example messaging over HTTP protocol request may be as follows:

POST /<endpoint>/?MailboxId=<GUID>@contoso.com HTTP/1.1
Host: mail.contoso.com
Content-Length: <length>
Content-Type: application/octet-stream
Cookie: MapiContext=<opaque string>
Cookie: MapiSequence=<opaque string>
X-RequestType: EcDoConnectEx
X-ClientInfo: <opaque string>
X-RequestId: <GUID>:<ID>
<RAW BINARY REQUEST BODY>

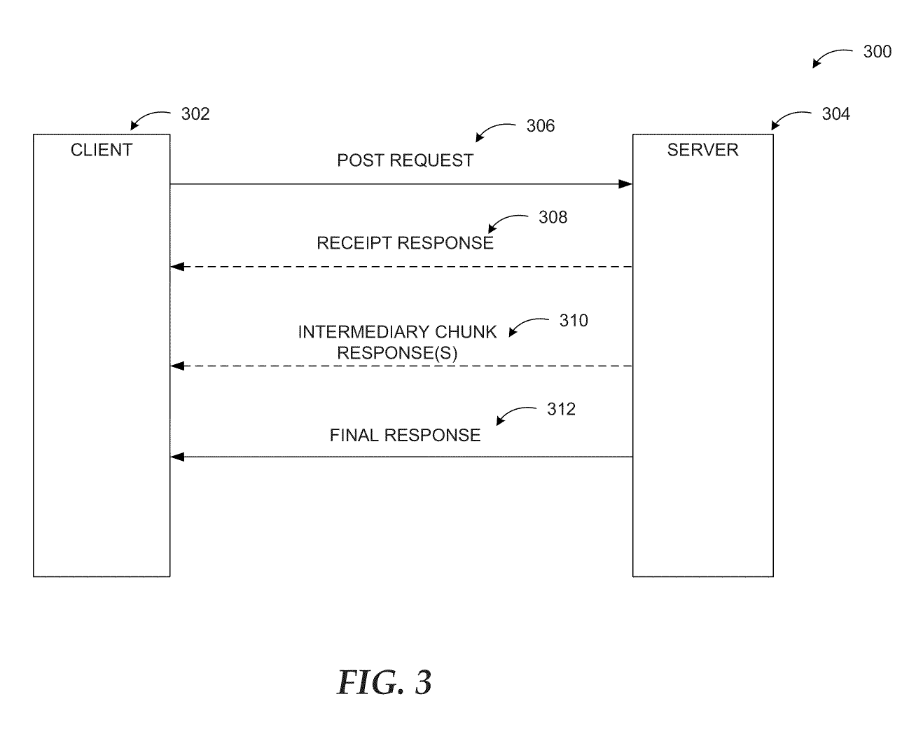

FIG. 3 illustrates example data requests and responses exchanged between a client and a server employing messaging over HTTP protocol, according to some example embodiments.

As previously described in conjunction with FIG. 2, a client 302 may utilize a standardized HTTP POST request in order to request data from a server 304 associated with an application executed at the client 302. The specialized data request language may be incorporate with the HTTP POST language to produce a messaging over HTTP protocol configured to instruct the server 304 what data to retrieve, where to retrieve it from, and how to respond to the client 302.

As illustrated in diagram 300, after the server receives an initial POST request 306, a series of responses may be returned to the client from the server. The POST request 306 may include instructions for the server 304 to respond to the initial POST request 306 with a receipt response 308 while the POST request 306 is being queued and processed by the server 304. The receipt response 308 may provide the client 302 with an acknowledgement that the server 304 has received the request in order to prevent the client 302 from being unaware of a dropped connection or unavailability of the server 304 to process a request. If the client 302 does not receive the receipt response 308 within a reasonable period of time, then the client 302 may abandon and/or retry the POST request 306.

In an example embodiment, the server 304 may be configured to return intermediary chunk responses 310 while the server 304 processes the POST request 306. The intermediary chunked responses 310 from the server may include a Transfer-Encoding header with “chunked” as the transfer encoding. The chunked transfer encoding may enable the server 304 to return intermediary responses and data to the client 302 while the POST request 306 is being processed by the server. The intermediary chunk responses 310 may be responses provided to the client 302 to provide a status of the request to the client 302 to indicate that the connection between the client 302 and server 304 has not been disconnected, and the server 304 is currently processing the POST request 306. If the client 302 does not receive an expected intermediary response within a reasonable period of time, then the client 302 may abandon and/or retry the POST request 306. An expected period of time for delivering intermediary responses may be defined by one of the client or the server and may also be a configurable setting. The intermediary chunk responses 310 may also serve to keep the underlying HTTP connection active while the server 304 processes the POST request 306.

An example chunked HTTP response from the server may be:

```
  HTTP/1.1 200 OK
  Host: mail.contoso.com
  Transfer-Encoding: chunked
  Content-Length: <length>
  Content-Type: application/octet-stream
  Cookie: MapiContext=<opaque string>
  Cookie: MapiSequence=<opaque string>
  X-RequestType: EcDoConnectEx
  X-ResponseCode: <value>
  X-ExpirationInfo: 900000
  X-ClientInfo: <opaque string>
  \r\n
  C\r\n
  PROCESSING\r\n
  \r\n
Periodically (configurable setting) the server will return another
keep-alive chunk:
  9\r\n
  PENDING\r\n
  \r\n
Until the request finally completes, and the result is returned:
  ?\r\n
  DONE\r\n
  X-ResponseCode: 0\r\n
  \r\n
  <RAW BINARY RESPONSE BODY>\r\n
  \r\n
  0\r\n
  \r\n
```

As illustrated in the above example response, when the server 304 completes the request, the server 304 may return a final response 312 to the client. A DONE meta-tag in the response may indicate the sending of the final response 312 to the client 302. The DONE meta-tag may be followed by an X-ResponseCode value to the client 302 with response data from the server 304. After the DONE meta-tag in the response, the server 304 may have the ability to return additional headers in the final response 312. The additional headers in the final response 312 may override header values the server 304 may have previously returned in one or more of the intermediary chunk responses 310. For example, the additional headers may enable the server 304 to subsequently fail the POST request, and to return a different X-ResponseCode value to the client 302. Response data from the server 304 may follow any additional headers. Furthermore, if an additional X-ResponseCode is returned and the response data is not a success, then no response data may follow the additional headers after the DONE meta-tag.

The example systems in FIG. 1 through 3 have been described with specific configurations, applications, and interactions. Embodiments are not limited to systems according to these examples. A system for providing a messaging over HTTP protocol for data exchange between a client and a server over a network may be implemented in configurations employing fewer or additional components and performing other tasks. Furthermore, specific protocols and/or interfaces may be implemented in a similar manner using the principles described herein.

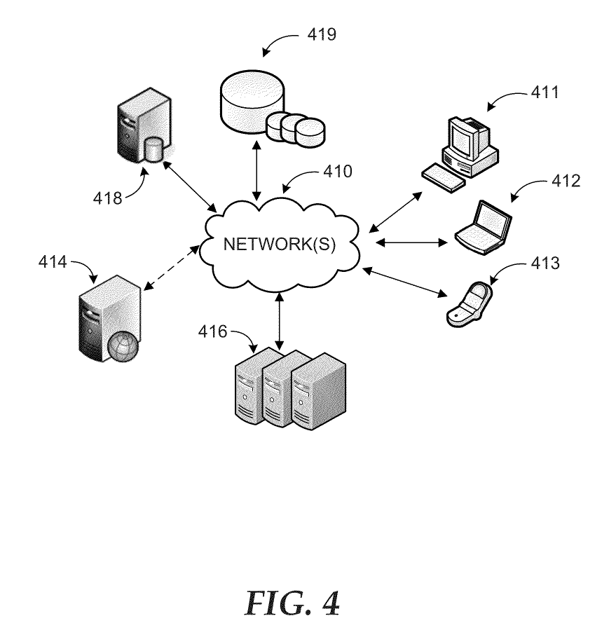

FIG. 4 is an example networked environment, where embodiments may be implemented. A system for providing a messaging over HTTP protocol for data exchange between a client and a server over a network may be implemented via software executed over one or more servers 414 such as a hosted service. The platform may communicate with client applications on individual computing devices such as a smart phone 413, a laptop computer 412, or desktop computer 411 (‘client devices’) through network(s) 410.

Client applications executed on any of the client devices 411-413 may facilitate communications via application(s) executed by servers 414, or on individual server 416. An application executed on one of the servers may facilitate data exchange via HTTP. The application may retrieve relevant data from data store(s) 419 directly or through database server 418, and provide requested services (e.g. document editing) to the user(s) through client devices 411-413.

Network(s) 410 may comprise any topology of servers, clients, Internet service providers, and communication media. A system according to embodiments may have a static or dynamic topology. Network(s) 410 may include secure networks such as an enterprise network, an unsecure network such as a wireless open network, or the Internet. Network(s) 410 may also coordinate communication over other networks such as Public Switched Telephone Network (PSTN) or cellular networks. Furthermore, network(s) 410 may include short range wireless networks such as Bluetooth or similar ones. Network(s) 410 provide communication between the nodes described herein. By way of example, and not limitation, network(s) 410 may include wireless media such as acoustic, RF, infrared and other wireless media.

Many other configurations of computing devices, applications, data sources, and data distribution systems may be employed to implement a platform for providing a messaging over HTTP protocol for data exchange between a client and a server over a network. Furthermore, the networked environments discussed in FIG. 4 are for illustration purposes only. Embodiments are not limited to the example applications, modules, or processes.

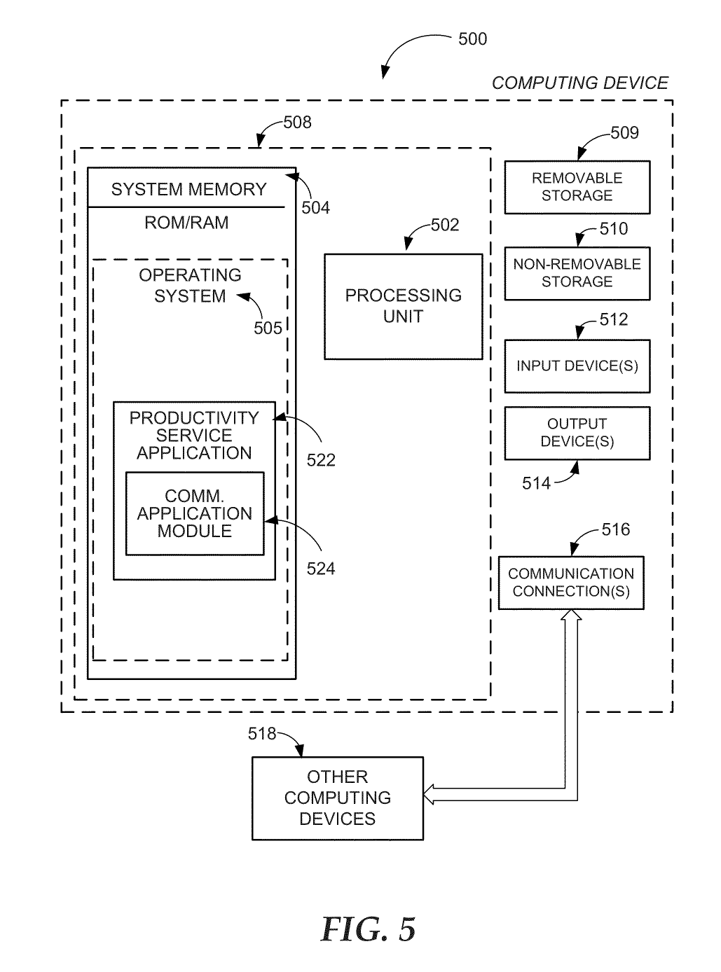

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may be any computing device executing an application for providing a messaging aver HTTP protocol for data exchange between a client and a server over a network according to embodiments and include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS® operating systems from MICROSOFT CORPORATION of Redmond, Wash. The system memory 504 may also include one or more software applications such as a productivity application 522 and a communication application module 524.

The productivity application 522 may be an application offering a variety of services such as an email application, a social networking application, a collaboration application, an enterprise management application, a messaging application, a word processing application, a spreadsheet application, a database application and a presentation application. A communication application module 524 as part of the productivity application 522 may enable a user to access and interact with data stored at a remote server, such as email, contacts and calendar data. Through the communication application module 526, the productivity application 522 may request data from the remote server employing a messaging over HTTP protocol. The messaging over HTTP protocol may provide instructions to the remote server for what data to retrieve and where to retrieve the data from, and may also instruct the remote server to send a receipt response and a series of chunk responses indicating a status of the processing of the request. Productivity application 522 and communication application module 526 may be separate applications or integrated modules of a hosted service. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wired or wireless network in a distributed computing environment, a satellite link, a cellular link, a short range network, and comparable mechanisms. Other devices 518 may include computer device(s) that execute communication applications, web servers, and comparable devices. Communication connection(s) 516 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

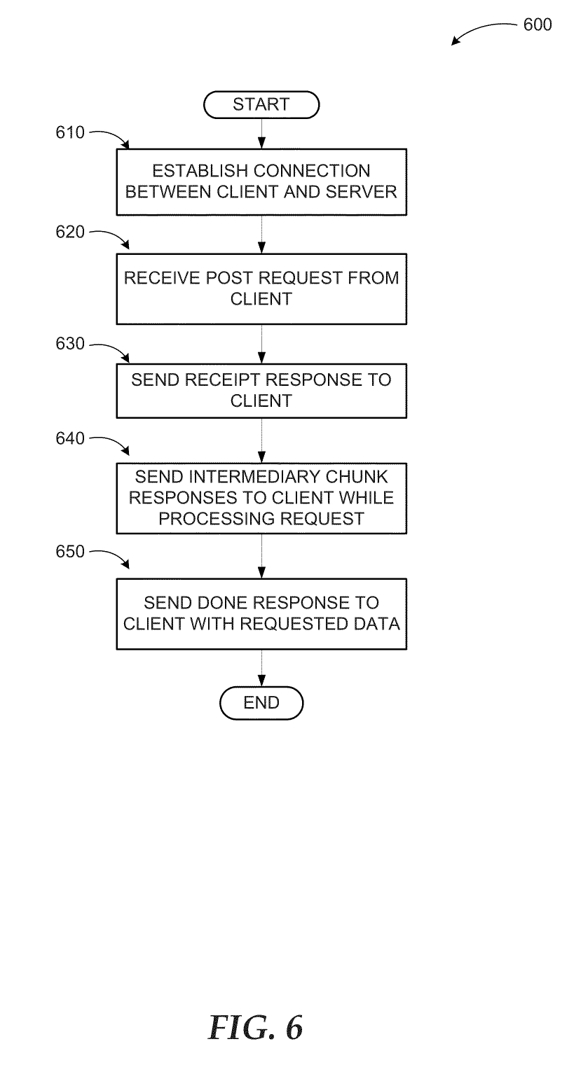

FIG. 6 illustrates a logic flow diagram for process 600 of providing a messaging over HTTP protocol for data exchange between a client and a server over a network, according to embodiments. Process 600 may be implemented on a computing device or similar electronic device capable of executing instructions through a processor.

Process 600 begins with operation 610, where a connection may be established between a client and server. A client may be a productivity service and a communication service accessing information and data from a remote server over a network, such as a cloud network. At operation 620, the server may receive a POST request from the client to initiate data retrieval at the server. The POST request may be a messaging over HTTP protocol which may include specialized headers with instructions for the data retrieval, including a request type header, a request identification header, a mailbox identification header and a content-type header. Operation 620 may be followed by operation 630 where the server may send a receipt response to the client upon receiving the POST request.

At operation 640, the server may send intermediary chunk responses to the client while the server processes the request. The intermediary chunk responses may indicate a status of the data request to the client, and may maintain the connection between the client and the server. The chunk responses may be sent at regular periods of time, which may be predefined and configurable. At operation 650, the server may send a DONE response to the client to indicate that the requested data has been retrieved, and the data may be provided to the client over the connection.

The operations included in process 600 are for illustration purposes. Providing a messaging over HTTP protocol for data exchange between a client and a server over a network may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device for providing a messaging over hypertext transfer protocol (HTTP) for data exchange between a client and a server over a network, the method comprising:
receiving a connection request at the server;
establishing the connection through HTTP;
receiving a data request over the connection;
in response to the data request, sending a receipt response;
processing the request to retrieve requested data; and
upon retrieving the requested data for the client, sending a final response.

2. The method of claim 1, wherein receiving the data request further comprises:
receiving a HTTP request.

3. The method of claim 2, further comprising:
receiving the HTTP request with one or more headers that include instructions for processing the data request.

4. The method of claim 3, wherein the headers include one or more of: a type header, a request identification header, a mailbox identification header and a content-type header.

5. The method of claim 4, wherein the type header specifies an operation the client is attempting to perform.

6. The method of claim 4, wherein the request identification header identifies the client to the server.

7. The method of claim 4, wherein the mailbox identification is a parameter that identifies an email account associated with the client from which the server is requested to retrieve data.

8. The method of claim 4, wherein the content-type header is set to an application/octet-stream.

9. The method of claim 1, further comprising:
sending a series of intermediary chunk responses while processing the request.

10. The method of claim 9, wherein sending the intermediary chunk responses further comprises:
including a header in at least a portion of the chunked responses, wherein the transfer encoding value is “chunked”.

11. The method of claim 10, further comprising:
sending the intermediary chunk responses at periodic time intervals while processing the data request, wherein the periodic time intervals are predefined and configurable.

12. A server for data exchange between a client and a server over a network, comprising:
a memory storing instructions;
a processor coupled to the memory, the processor executing a data retrieval application, wherein the data retrieval application is configured to:
receive a connection request;
establish the connection through hypertext transfer protocol (HTTP);
receive a data request over the connection;
in response to the data request, send a receipt response;
process the request to retrieve requested data;
send a series of intermediary chunk responses while processing the request; and
upon retrieving requested data for the client, send a final response.

13. The server of claim 12, wherein the server is associated with a productivity service providing one or more of: an email application, a social networking application, a collaboration application, an enterprise management application, a messaging application, a word processing application, a spreadsheet application, a database application, a presentation application, and an email, contacts and calendaring management application.

14. The server of claim 12, wherein the data request is an HTTP request including one or more headers with instructions for how to process the data request.

15. The server of claim 14, wherein the headers include one or more of: a type header, a request identification header, a mailbox identification header and a content-type header.

16. The server of claim 15, wherein the type header specifies an operation the client is attempting to perform, the request identification header identifies the client to the server, the mailbox identification is a parameter that identifies an email account associated with the client from which the server is requested to retrieve data, and the content-type header is set to an application/octet-stream.

17. The server of claim 12, wherein the series of intermediary chunk responses include a header in the chunked response with “chunked” as a transfer encoding value.

18. The server of claim 12, wherein the data retrieval application is further configured to:
include a DONE meta-tag in the final response to indicate a sending of a final response to the client, wherein the DONE meta-tag is followed by a value with requested data from the server.

19. A computer-readable memory device with instructions stored thereon for providing a messaging over hypertext transfer protocol (HTTP) protocol for data exchange between a client and a server over a network, the instructions comprising:
receiving a connection request at the server;
establishing the connection through HTTP;
receiving an HTTP POST data request over the connection;
in response to the data request, sending a receipt response;
processing the request to retrieve requested data;
sending a series of intermediary chunk responses while processing the request at regular time intervals; and
upon retrieving requested data for the client, sending a final response.

20. The computer-readable memory device of claim 19, wherein the instructions further comprise:
including a DONE meta-tag in the final response to indicate a sending of the final response to the client with the requested data, wherein the DONE meta-tag is followed by a value with requested data from the server; and
enabling the server to return additional headers in the final response, wherein the additional headers in the final response override header values included in one or more of the intermediary chunk responses.
